(19) United States
(12) Patent Application Publication
(10) Pub. No.: US 2016/0246333 A1
(43) Pub. Date: Aug. 25, 2016

(54) Stand for Supporting Device in a Plurality of Viewing Angles

(71) Applicant: HEWLETT-PACKARD DEVELOPMENT COMPANY, L.P., Houston, TX (US)

(72) Inventors: DIMITRE MEHANDJIYSKY, HOUSTON, TX (US); AKI LAINE, HOUSTON, TX (US); MICHAEL DELPIER, HOUSTON, TX (US)

(21) Appl. No.: 15/024,847

(22) PCT Filed: Nov. 14, 2013
(86) PCT No.: PCT/US13/70205

§ 371 Date: Mar. 24, 2016

(51) Int. Cl. G06F 1/16

(52) U.S. Cl. CPC G06F 1/1656; G06F 1/1637; G06F 1/1616; G06F 1/1681

(57) ABSTRACT

Examples disclosed herein provide a stand to support a device in a plurality of viewing angles. The stand can include a first portion, including a power source, and a second portion pivotally attached to the first portion and detachably coupled to a sidewall of the device.

### BACKGROUND

The emergence and popularity of mobile computing has made portable computing devices, due to their compact design and light weight, a staple in today's marketplace. Tablet computers are examples of portable computing devices that are widely used. Tablet computers are single units generally employing a touchscreen on a display surface of the tablet that may be used for both viewing and input. Users of tablets may interact with the touchscreen via finger or stylus gestures. While handling the tablet in their hands, a user may have the flexibility to view the display surface in a plurality of viewing angles, according to user preference.

### BRIEF DESCRIPTION OF THE DRAWINGS

FIG. 1 illustrates an accessory for a portable computing device such as a tablet computer, according to an example;

FIG. 2 illustrates detachable stand for a portable computing device with a removable power source, according to an example; and

FIGS. 3A-C illustrate different views of a system including a portable computing device used with the detachable stand, according to an example.

### DETAILED DESCRIPTION

While using a portable computing device, such as a tablet computer, there may be instances when users may desire to have their hands free bile using the device, particularly when the device is used for a prolonged period of time (e.g., for media consumption, such as watching a movie). Laying the tablet computer flat on a surface, such as a table, may not provide a desirable viewing angle of the display surface for a user. Accessories are available for tablet computers that allow users to have their hands free and view the display surface of the tablet at an appropriate viewing angle. Such accessories may be fitted to a tablet computer in various form factors.

When designing such accessories, factors that may be considered include at east aesthetics and ease of use. When choosing a tablet accessory, users may consider the overall appearance of the tablet computer when fitted with the accessory. With regards to ease of use, users may consider the ease of adding and removing the accessory from the tablet, and the ease of using the accessory while it is fitted to the tablet. For example, users may consider whether the system including the accessory fitted to the tablet is stable and sturdy for use on various surfaces (e.g., on the lap of a user or a level surface, such as a desk or table).

37 Examples disclosed herein provide an accessory for a portable computing device such as a tablet computer. The accessory may function as a detachable stand by supporting the tablet in a plurality of viewing angles.

In one example, a system can include a portable computing device, including a display surface and a back surface opposite the display surface, and a stand to support the device in a plurality of viewing angles. The stand can include a first portion, including a power source, and a second portion pivotally attached to the first portion and detachably coupled to a sidewall of the device.

In another example, a detachable stand is included for supporting a device in a plurality of viewing angles. The stand can include a first portion, including a power source, and a second portion pivotally attached to the first portion and detachably coupled to a sidewall of the device. The second portion can include protrusions to occupy cavities within the sidewall of the device when the device is coupled to the stand.

In yet another example, a system can include a portable computing device, including a display surface and a back surface opposite, the display surface, and a stand to support the device in a plurality of viewing angles. The stand can include a first portion, including a power source, and a second portion pivotally attached to the first portion and detachably coupled to a sidewall of the device, wherein the first portion is rotatable towards the back surface of the device. The stand can include a hinge mechanism to pivotally attach the second portion to the first portion, wherein the hinge mechanism is to support the device in the plurality of viewing angles.

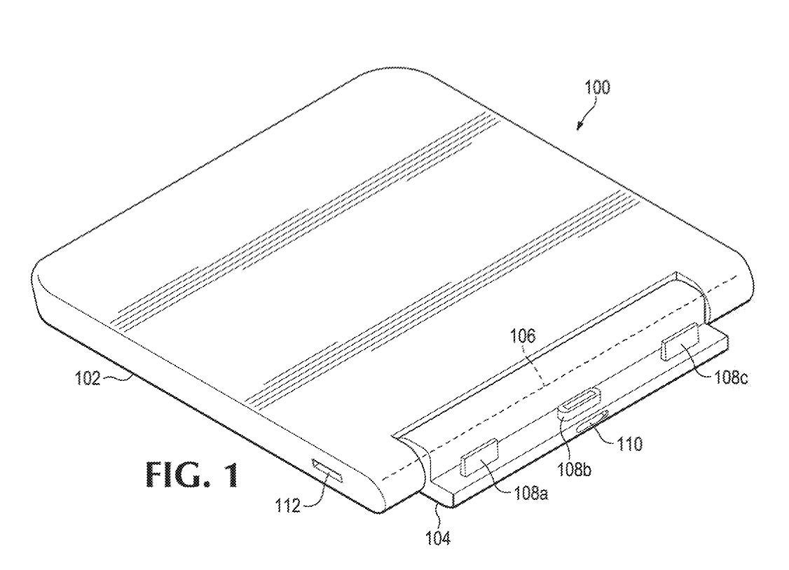

With reference to the figures. FIG. 1 illustrates an accessory 100 for a portable computing device such as a tablet computer, according to an example. The accessory 100 may function as a detachable stand by supporting the tablet in a plurality of viewing angles, as will be further described. The stand 100 may include a first portion 102 and a second portion 104 pivotally attached to the first portion 102 sharing a common axis at 106). The thickness and shape of the stand 100 may vary. For example, the thickness of the stand 100 may depend on internal components disposed within the stand 100 (e.g., a power source, such as a rechargeable battery).

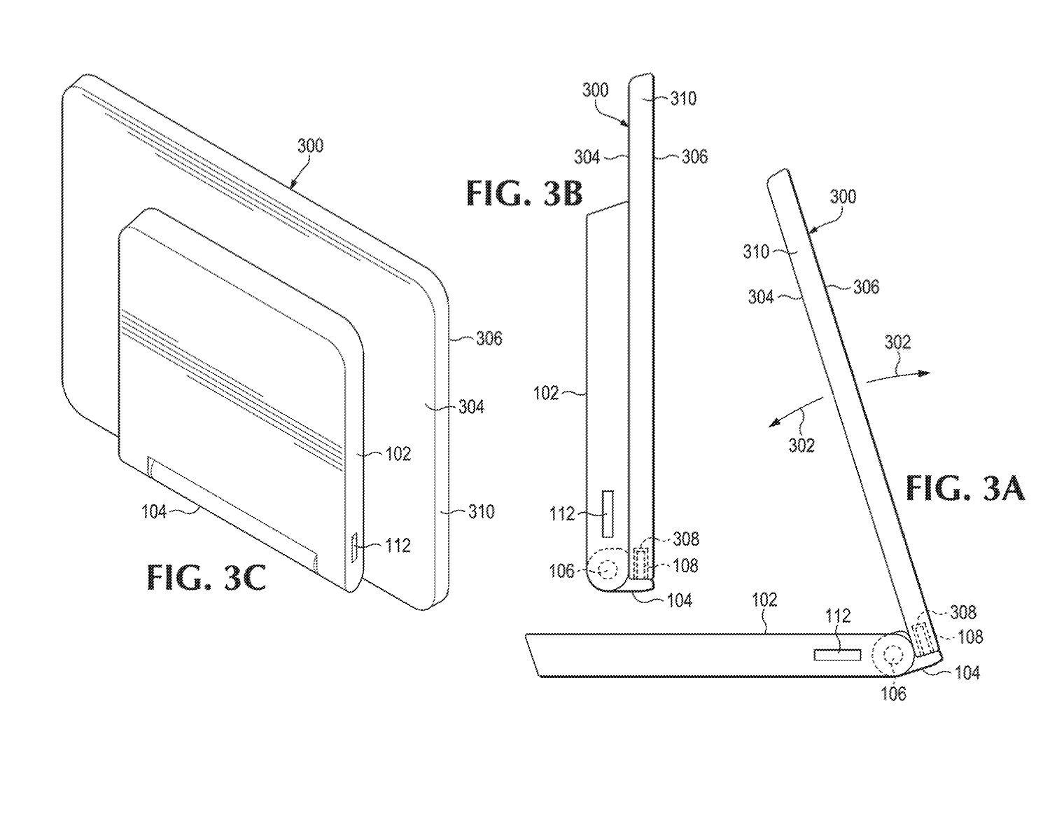

The second portion 104 of the stand 100 may be detachably coupled to a sidewall of the tablet (e.g., see FIG. 3B). As an example, the second portion 104 of the stand 100 may include one or more protrusions 108 to occupy cavities within a bottom sidewall of the tablet when the tablet is coupled to the stand 100. By occupying the cavities within the bottom sidewall of the tablet, the protrusions 108 may secure the tablet to the stand 100, and provide an appropriate level of stability and sturdiness while handling the tablet when it is coupled to the stand 100. As an example, the stand 100 may include a latching mechanism (not shown) to secure one or more of the protrusions (e.g., protrusions 108a, 108c) within the cavities of the tablet. The latching mechanism may be released, for example, by a re/easing mechanism 110 when it is desirable to detach the tablet from the stand 100. Although FIG. 1 illustrates the releasing mechanism 110 for controlling the latching mechanism, the tablet may be secured to the stand 100 in a number of other ways. As an example, the tablet may be magnetically coupled to the stand 100 via the protrusions 108, as will be further described.

As an example, the tablet may be communicatively and/or electrically coupled to the stand 100 via one or more of the protrusions 108 (e.g., conductive connector 108b). As an example, the first portion 102 of the stand 100 may include a power source, such as, but not limited to, a rechargeable battery. When connecting the connector 108b with a charging port located on the bottom sidewall of the tablet, the connector 108b may electrically couple the power source with the tablet. By supplementing an internal power source that may be disposed within the tablet (e.g., one or more rechargeable batteries), the power source included in the stand 100 may provide additional power for operating the tablet. As tablet computers may have a reduced size and/or thickness in order to make it practical for users to handle tablets in their hands, the capacity of the battery disposed within the tablet may also be limited, due to the limitation in space. As a result, the supplemental power source included in the stand 100 may extend the use time of the tablet in between charges.

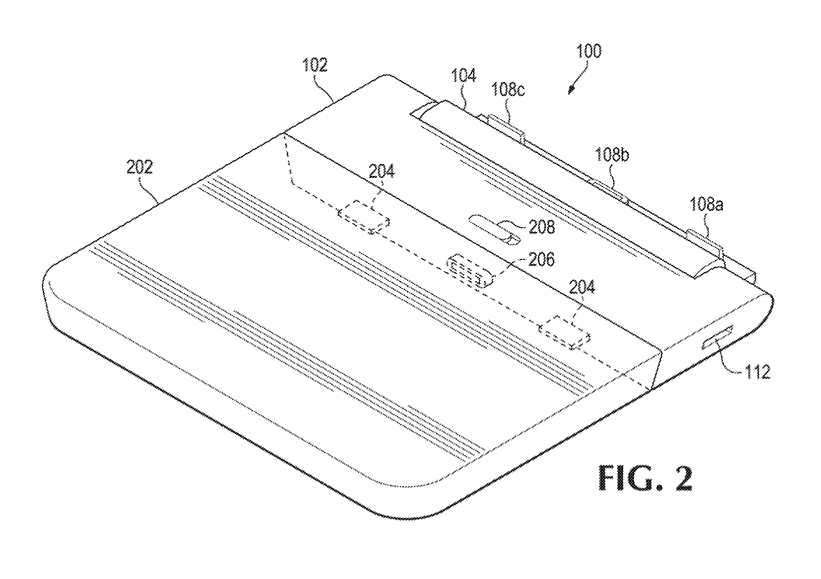

FIG. 2 illustrates detachable stand 100 with a removable power source 202, according to an example. As an example, the removable power source 202 may be a rechargeable battery that is detachably coupled to the first portion 102 of the stand 100 according to various methods. As an example, an end of the first portion 102 may include an electrical connector 206 to electrically connect the power source 202 to provide a power signal to the stand 100. As an example, the electrical connector 206 may include electrical contacts, pogo pins, and the like.

The power source 202 may be secured to the first portion 102 of the stand 100 via protrusions 204 according to various methods such as, but not limited to, via a latching mechanism and/or magnetic coupling. With regards to a latching mechanism, a releasing mechanism 208 may be included for releasing the latching mechanism when it is desirable to detach the power source 202 from the first portion 102. With regards to magnetic coupling, one or more of the protrusions 204 may include magnetically active components that provide an associated magnetic field to cooperatively interact with the magnetic fields generated by magnetically active components included in one or more cavities of the power source 202 for receiving the protrusions 204.

Although FIG. 2 illustrates that the stand 100 includes a power source 202 that is removable, the power source 202 may also be irremovable. As an example, the entire first portion 102 of the stand 100 may be a power source (e.g., see FIG. 1), or the power source may be disposed within the first portion 102. As an example, the power source may be removable from the first portion 102 via an access door (not shown). The stand 100 may include a port 112 for powering or charging the power source 202, for example, via an AC power plug. As an example, the weight of the first portion 102 including the power source may be sufficient to function,as a base while operating the tablet in the plurality of viewing angles. As a result, a system including the stand 100 and the tablet may be stable and sturdy for a use on a surface in the plurality of viewing angles.

Referring back to FIG. 1, the second portion 104 of the stand 100 may be pivotally attached to the first portion 102 via a hinge mechanism indicated by dashed line 106. In order to support a tablet in a plurality of viewing angles when coupled to the stand 100, the hinge mechanism 106 may provide a level of resistance when rotating the second portion 104 with respect to the first portion 102 that may only be overcome by sufficient force (e.g., torque). As an example, the hinge mechanism 106 may include a friction hinge, which is a device with torque between the first portion 102 and the second portion 104 on a common axis, such as a shaft of the hinge mechanism 106. As an example, the hinge mechanism 106 may include a detent hinge, which is a device that provides “soft stops” in one or more positions between the first portion 102 and the second portion 104 on a common axis, providing one or more viewing angles. By providing a level of resistance when rotating the second portion 104 with respect to the first portion 102, the hinge mechanism 106 may support the tablet in a variety of viewing angles, based according to user preference.

FIGS. 3A-C illustrate different views of a system including a p portable computing device 300 used with the detachable stand 100, according to an exaple As mentioned above, the thickness and shape of the stand 100 may vary. For example, the thickness of the stand 100 may depend on internal components disposed within the stand 100 and/or the power source 202 When the system is not being handled in the hands of a user, the system may be used on various surfaces, allowing the user to adjust the viewing angle of the device 300, indicated by arrows 302. As an example, the surface may be a level surface such as, for example, a desk or table, or a surface that is not level. The weight of the first portion 102 including the power source may be sufficient to function as a base while operating he tablet in the plurality of viewing angles. As a result, the system including the stand 100 and the device 300 may be stable and sturdy for use on the surface in the plurality of viewing angles.

Examples of the device 300 include; but are ere not limited to, a smart phone or a tablet. The device 300 may include a display surface 306 and a back surface 304 opposite the display surface 306. The display surface 306 may be a touchscreen, allowing a user to interact directly with what is displayed by touching the screen with simple or multi-touch gestures. Although the figures illustrate that the back surface 304 includes a flat surface, the back surface 304 may include a plurality of different surfaces, such as a convex surface. In between the display surface 306 and the back surface 304, the device 300 may include sidewalls 310 around a perimeter of the device 300. As an example, the device 300 may include four sidewalls 310 (e.g., a left sidewall, a right sidewall, a top sidewall, and a bottom sidewall). Although a user may be able to view the device 300 in a portrait or landscape orientation, the bottom sidewall may refer to the same sidewall 310 of the device 300.

As described above, the second portion 104 of the detachable stand 100 may include one or more protrusions 108 to occupy cavities 308 within the bottom sidewall of the device 300 when the device 300 is coupled to the stand 100, as illustrated in FIG. 3A. As an example, the number of cavities 308 within the bottom sidewall of the device 300 may correspond to the number of protrusions 108. One of the cavities 308 may be a port for communicatively and/or electrically coupling with connector 108b. Coupling the stand 100 to the bottom sidewall of the device 300 may provide an appearance of oneness by in which the stand 100 and the device 300 can appear as a single, unified entity, providing a uniformity in appearance and contributing to the overall aesthetic appeal of the system.

By occupying the cavities 308 within the bottom sidewall of the device 300, the protrusions 108 may secure the device 300 to the stand 100, and provide an appropriate level of stability and sturdiness while handling the device 300 when it is coupled to the stand 100. The device 300 may be detachably coupled to the stand 100 via the protrusions 108 according to various methods such as, but not limited to, via a latching mechanism and/or magnetic coupling. Referring to FIG. 1, for a device coupled to the stand 100 by a latching mechanism, the stand 100 may include a releasing mechanism 110 for releasing the latching mechanism when it is desirable to detach the device from the stand 100.

With regards to magnetic coup, ng, one or more of he protrusions 108 may include a variety of magnetically active components that provide an associated magnetic field to cooperatively interact with the magnetic fields generated by the magnetically active components included in one or more cavities 308. When the protrusions 108 are placed within proximity of the cavities 308, the stand 100 and the device 300 may remain in a magnetically attached state if and until a releasing force of sufficient magnitude is applied that overcomes the overall net attractive magnetic force between the protrusions 108 and the cavities 308. As an example, either the protrusions 108 or the cavities 308 may include magnetically passive elements that can interact with the magnetic fields generated by the other components. Examples of magnetically passive elements include, but are not limited to, ferromagnetic materials such as iron or steel.

Properties of the magnetically active components that may be controlled include, but are not limited to, field strength and magnetic polarity. As an example, the magnetically active components used to magnetically attach the device 300 to the stand 100 can assure the device 300 may only attach to the stand 100 in a specific orientation. For example, it may not be desirable to attach the device 300 to the stand 100 with the display surface 306 facing the first portion 102 of the stand 100. As an example, this reverse orientation may be avoided by controlling properties of one or more of the magnetically active components, such as magnetic polarity.

Referring back to FIG. 1, the magnetic member included in protrusion 108a may require a north pole of a magnetic member disposed within a cavity 308 f the device 300, and magnetic member included in protrusion 108c may require a south pole of a magnetic member disposed in another cavity 308, in order to generate an attractive magnetic force between the device 300 and the stand 100. As a result, any attempt to attach the device 300 and stand 160 in a reverse orientation may generate a repulsive magnetic force rather than an attractive magnetic forte. In addition to ensuring that the stand 100 may only attach to the device 300 in a specific orientation, the magnetic members may also assure paper alignment and positioning of the stand 100 with respect to the device 300. As a result, a user may attach the stand 100 to the device 300 in a desirable and repeatable manner, such they are consistently in a pre-determined position relative to one another. This desirable and repeatable manner may also be accomplished by latching mechanism described above.

In addition to functioning as a stand for supporting the device a plurality of viewing angles, the stand 100 may include ports, in addition to port 112, to provide, the device 300 connectivity to accessories or peripherals for the device. As an example, the stand may include one or more Universal Serial Bus (USB) ports for connecting accessories, such as a mouse and/or keyboard. Examples of other ports include, but are not limited to, HDMI, Thunderbolt, and an audio jack. In addition to ports that require physical connections, accessories may communicate with the system by other forms of communication that may not require a physical connection, such as a form of wire less communication (e.g., Bluetooth). Any accessories connected to the stand 100 may be communicatively coupled to the device 300 via the connector 108b and/or a form of wireless communication (e.g., Bluetooth).

Referring to FIG. 3B, the first portion 102 of the stand 100 may be rotatable to yards the back surface 304 of the device 300. The mode illustrated in FIG. 3B may be appropriate when a user desires to handle and use the system in their hands. As an example, the surface of the first portion 102 that comes in contact with the back surface 304 of the device 300 may be shaped to form a well matched fit to each other, providing a uniformity in appearance and contributing to the overall aesthetic appeal of the system. As illustrated in FIGS. 3B-C, the sides of the first portion 102 may be tapered to match one or more of the sidewalls 310 of the device 300, which may also contribute to the overall aesthetic appeal of the system. As an example, the shape of the first portion 102 of the stand 100 may take various forms. For example, the first portion 102 may be block-shaped with fiat edges, or any other form that may provide support for viewing the device 300 in a plurality of viewing angles.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described detail avoid unnecessarily obscuring the description of the examples Also, the examples may be used in combination with each other.

Reference in the specification to “an example” or similar language means that a particular feature, structure, or characteristic described in connection with the example is included in at least one example, but not necessarily in other examples. The various instances of the phrase “In one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be, applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A system: comprising:
a portable computing device including a display surface and a back surface opposite the display surface; and
a stand to support the portable computing device in a plurality of viewing angles, the stand comprising:
a first portion including a power source; and
a second portion pivotally attached to the first portion and detachably coupled to a sidewall of the portable computing device.

2. The system of claim 1, wherein the first portion is rotatable towards the back surface of the portable computing device.

3. The system of claim 1, wherein the second portion comprises protrusions to occupy cavities within the sideman of the portable computing device when the device is coupled to the stand.

4. The system of claim 3, wherein the protrusions comprise a connector to electrically couple the power source with the portable computing device when the connector is connected with a port of the portable computing device.

5. The system of claim 3, wherein the stand comprises a latching mechanism to secure one or more of the protrusions within the cavities when the portable computing device is coupled to the stand.

6. The system of claim 1, wherein the second portion of the stand is pivotally attached to the first portion via a hinge mechanism to support the portable computing device in the plurality of viewing angles.

7. The system of claim 1, wherein the fuss portion of the stand comprises ports to provide the portable computing device connectivity to accessories for the portable computing device.

8. A detachable stand to support a portable computing device in a plurality of viewing angles, the stand comprising:
a first portion including a power source;
a second portion pivotally attached to the first portion and detachably coupled to a sidewall of the portable computing device, wherein the second portion comprises protrusions to occupy cavities within the sidewall of the portable computing device when the portable computing device is coupled to the stand.

9. The detachable stand of claim 8, wherein the protrusions comprise a connector to electrically couple the power source with the portable computing device when the connector is connected with a port of the portable computing device.

10. The detachable stand of claim 8, wherein the first portion of the stand is rotatable towards a back surface of the portable computing device.

11. The detachable stand of claim 8, comprising:
a latching mechanism to secure one or more of the protrusions within the cavities when the portable computing device is coupled to the stand.

12. The detachable stand of claim 8, comprising:
a hinge mechanism to pivotally attach the second portion to the first portion wherein the hinge mechanism is to support the portable computing device in the plurality of viewing angles.

13. The detachable stand of claim 8, wherein the power source a rechargeable battery detachably coupled to the first portion.

14. A system, comprising:
a portable computing device including a display surface and a back surface opposite the display surface; and
a stand to support the portable computing device in a plurality of viewing angles, the stand comprising:
a first portion including a power source;
a second portion pivotally attached to the first portion and detachably coupled to a sidewall of the portable computing device, wherein the first portion is rotatable towards the back surface of the portable computing device; and
a hinge mechanism to pivotally attach the second portion to the first portion, wherein the hinge mechanism is to support the portable computing device in the plurality of viewing angles.

15. The system of, claim 14, wherein the second portion comprises protrusions to occupy cavities within the sidewall of the portable computing device when the device is coupled to the stand.
